(19) United States
(12) Patent Application Publication
(10) Pub. No.: US 2025/0263560 A1
(43) Pub. Date: Aug. 21, 2025

(54) LOW PVC MATT PAINT FORMULATIONS

(71) Applicant: LAMBERTI SPA, Albizzate (IT)

(72) Inventors: Simona ESPOSITO, Gallarate (IT); Max GIUDICI, Lomazzo (IT); Barbara GATTI, Legnano (IT)

(73) Assignee: LAMBERTI SPA, Albizzate (IT)

(21) Appl. No.: 18/857,681

(22) PCT Filed: May 2, 2023
(86) PCT No.: PCT/EP2023/061466

§ 371 Date: Oct. 17, 2024

(30) Foreign Application Priority Data
May 3, 2022 (IT) 102022000008990

(51) Int. Cl. C09D 7/62; C08K 3/32; C08K 9/02; C09D 5/02; C09D 7/40; C09D 7/42; C09D 7/61; C09D 133/04

(52) U.S. Cl. CPC C09D 7/62; C09D 5/022; C09D 7/42; C09D 7/61; C09D 7/69; C09D 133/04; C08K 2003/325; C08K 9/02; C08K 2201/005

(57) ABSTRACT

The present invention relates to (i) low PVC paint formulations having excellent matt characteristics at high angles of incidence comprising at least one pigment and/or one filler, at least one binder and, as matting agent, a hydroxyapatite having specific particle dimensions; and (ii) a method for imparting excellent matt characteristics to a high gloss paint coating comprising the use of said paint formulations.

### TECHNICAL FIELD

The present invention relates to low PVC paint formulations having excellent matt characteristics at high angles of incidence comprising at least one pigment and/or one filler, at least one binder and, as matting agent, a hydroxyapatite having specific particle dimensions.

The present invention relates to a method for imparting excellent matt characteristics to coating obtained with a low PVC paint comprising the use of said paint formulations.

### BACKGROUND OF THE INVENTION

Paints are surface coatings that are applied to substrates and are dried to form continuous films for decorative purposes as well as to protect the substrate. Consumer paints are air-drying and primarily decorative architectural coatings applied to interior or exterior surfaces, where the coatings are sufficiently fluid to flow and form a continuous paint film and subsequently dry at ambient temperatures. Industrial maintenance paints are similar coatings applied to substrates in industrial environments primarily to protect the substrate.

Latex paints, also known as emulsion paints and coatings, have captured a significant portion of the indoor and outdoor paint market as a result of the many advantages that such paints have over solvent-based products. They ordinarily comprise organic polymeric binders, pigments, and various paint additives. In dried paint films, the polymeric binder functions as a binder for the pigments and provides adhesion of the dried paint film to the substrate. The pigments may be organic or inorganic and functionally contribute to opacity and color, in addition to durability and hardness, of the dried paint film.

There are cases when it is most desirable that the paints possess low gloss (matt) property, which is generally achieved by incorporating in the paint formulations a matting agent, which roughen or contour the surface of the film in the micro range. Thus, impinging light is no longer reflected directionally, but diffusely. The height, shape and number of the surface structures determine the degree of gloss of the paint film.

Examples of these matting agents are inorganic fine powder of silica, alumina, or calcium carbonate etc., or bead-type fine particles, made of polyethylene resin, polyurethane resin, epoxy resin, polyamide resin, polyester resin etc.

The gloss of a paint is a function of the pigment volume concentration (PVC), i.e. the higher the PVC, the lower the gloss. Consequently, the addition of a matting agent is particularly necessary in low PVC paints, also known as “high gloss paints” (PVC<50). These paints, which are considered high quality products, contain high levels of binder and, especially at very low PVC values, are known for being super shiny and light reflecting, giving to the substrate an almost mirror-like look.

Unfortunately many conventional matting agents used in such paints show low gloss reduction at high angle of incidence. Low gloss at high angle of incidence is a very important requirement especially for application on large surfaces, as it ensures a homogeneous appearance of the entire coated area from all observation points.

In addition, these matting agents often create significant disadvantages in the preparation, handling and performances of the paint formulations. Above all, the matting effect increases with the dosage of the matting agent. This leads to a significant increase in viscosity of the formulation when matting efficiency is low, which makes the production, handling and processing more difficult. Inorganic matting particles also tend to settle out of formulations.

Further, while effective at reducing gloss, the matting particles often disrupt film integrity and can lead to loss of key film properties such as water and abrasion resistance and slip. This results in a quick wear and unaesthetic appearance of the mat surface.

Still further, some matting agents tend over the time to polish or burnish after rubbing, leading to an increase in the gloss over time.

Finally, the matting agents based on silica are dangerous to handle because of their health problems and strong tendency to dusting.

As a consequence, there is still the need in the art of finding a matting agent which allows to overcome all the above mentioned problems.

Now, we have surprisingly found that hydroxyapatites (HAp) having specific particle dimensions shows advantageous characteristics as matting agents when incorporated in low PVC paints.

As compared with conventional matting agents, the hydroxyapatites of the invention show particularly low gloss values at all observation angles, in particular at high angles, i.e. 85°. This means that in order to achieve a certain matting effect less material is needed than in the case of conventional matting agents or for a given amount of matting agent an improved effect is achieved.

HAp is fully compatible with the low PVC paint formulations and does not sensibly increase their viscosity.

Finally, being biocompatible, hydroxyapatite does not pose health problems.

As far as the Applicant knows, no one has previously described the Hap of the present disclosure and its advantageous properties

The paint formulations of the invention may be used as such as low PVC paints for architectural interior and exterior coatings applied onsite to stationary structures, such as residential, commercial, institutional and industrial buildings, and their appurtenances, to portable buildings or to pavements; the paint formulations may also be formulated to include further conventional ingredients of low PVC paints.

In the present invention, all the particle dimension parameters, i.e. Dv10, Dv50, Dv90, Dv100 and Mode, were derived from volume-based distributions, as determined with a laser diffraction particle size analyzer, e.g. a Mastersizer 3000 (Malvern Pananalytical).

The definition “paint formulation with excellent matt characteristic” indicates paint formulations having a gloss at 85° below 20, preferably below 15.

The definition “high gloss paint” indicates a paint formulation having a percent PVC below 50%.

In the present invention, all the percentage by weight, unless otherwise specified, are based on the total weight of the formulations.

### DESCRIPTION OF THE INVENTION

It is therefore an object of the present invention a paint formulation having a percent pigment volume concentration (PVC) comprised between 5 and 50% and excellent matt characteristics comprising at least one pigment and/or one filler, at least one binder and, as matting agent, from 0.5 to 15% by weight (wt %) of a hydroxyapatite (Hap) having a Dv50 of between 10 and 50 μm, a Dv90 below 85 μm and a Dv10 above 3 μm, as determined with a laser diffraction particle size analyzer.

It is another object of the invention a method for imparting excellent matt characteristics to a coating obtained with a paint having percent PVC<50% comprising the step of:
i) preparing said paint formulation;
ii) optionally adding into the paint formulation water or other conventional paint additives;
iii) applying the resulting paint formulation having percent PVC<50% onto a substrate.

### BRIEF DESCRIPTION OF THE DRAWINGS

FIG. 1. SEM image of the spray-dried Hap1.

FIG. 2. SEM image of the grinded Hap5.

### DETAILED DESCRIPTION OF THE INVENTION

The paint formulations of the invention can be provided both as dry mix paint formulations, typically to be dispersed in water before use, or, preferably, as liquid aqueous paint formulations, in particular as waterborne latex paint formulations.

Paints are commonly characterized in terms of their pigment volume concentration (PVC), which is the volume relationship of pigment/filler to total solids in the dry paint film. The percent PVC is calculated with the following formula:

$$\% PVC = \frac{Vf + Vp}{Vf + Vp + Vb} \times 100$$

where
Vₚ is the total pigment volume,
V_{f} is the total filler volume,
V_{b} is the total binder volume.

The value of the percent PVC for the paint formulations of this invention can range between 5 and 50%, preferably between 10 and 40%, more preferably between 10 and 30%.

Pigments suitable for the realization of the present invention are those commonly used in the water-based architectural paints. Specific examples of suitable pigments are inorganic white pigments, inorganic chromatic pigments, organic pigments, carbon blacks and inorganic black pigments. Preferred pigments are inorganic metal oxides, hydroxides, sulfates, carbonates, organic pigments and mixtures thereof. As inorganic white pigments, mention should be made in particular of oxides, such as titanium dioxide, zinc oxide (ZnO), zirconium oxide, carbonates and sulfates, such as lead sulfate; titanium dioxide being particularly preferred. As inorganic chromatic pigments, mention should be made of those from the group of oxides and hydroxides in the form of their individual inorganic compounds or mixed phases, especially iron oxide pigments, chromium oxide pigments and oxidic mixed-phase pigments with rutile or spinel structure. Examples of iron oxide pigments are Colour Index Pigment Yellow 42 and Pigment Red 101. Examples of chromium oxide pigments are Colour Index Pigment Green 17 and Pigment Green 18. Examples of oxidic mixed-phase pigments are nickel-titanium yellow and chromium-titanium yellow, cobalt green and cobalt blue. Examples of inorganic black pigments that should be mentioned include those as already described above together with the inorganic chromatic pigments, in particular black iron oxide and black oxidic mixed-phase pigments. Examples of preferred organic pigments are those of the monoazo, disazo, azo-lake, beta-naphthol, azo metal complex series, and also polycyclic pigments such as those from the phthalocyanine, quinacridone, and thioindigo series. Also suitable as organic pigments are lake-dyes such as Ca, Mg and Al lake-dyes containing sulphonic acid or carboxylic acid groups, and also carbon blacks. Mention should be made in particular of carbon blacks obtained by the furnace black process, and also chemically surface-modified carbon blacks, such as sulpho-or carboxyl-containing carbon blacks.

In a preferred embodiment, the paint formulation of the invention does not contain any pigment based on a metallic powder.

Fillers, also called extender pigments, comprise substances other than the pigments mentioned, these substances being primarily light in color and being inert towards the binder component. With particular preference, the fillers have a lower optical refractive index than the aforementioned white pigments. Examples of inorganic fillers that may be mentioned include carbonates, such as chalk, calcite or dolomite, silicon dioxide (ground quartz), natural or synthetic silicas, silicates, such as talc, kaolin or mica, and sulfates such as barium sulfate. Examples of organic fillers include polymeric powders and those known as hollow spheres.

The binder suitable for the preparation of the paint formulation of the invention may be any standard type and may include different binder materials. Suitable binders include both organic and inorganic compounds. Preferred organic binders are water-soluble, water-dispersible or water-emulsifiable, natural, natural-modified or synthetic, film-forming compounds. Examples of natural binders include natural resins, such as rosin or schellac, natural oils, especially oils containing fatty acids which are saturated or contain various degrees of unsaturation, said oils being oxidatively drying if desired, such as linseed oil, ricinene oil, soya oil, castor oil, and the like. Modified natural binders are, in particular, chemically modified natural resins, e.g. rosin-maleate resin, and modified oils, e.g. isomerized oils, styrenated and acrylated oils, and also cellulose derivatives such as cellulose nitrates, cellulose esters of organic acids. Examples of synthetic binders are saturated polyesters obtained by polyesterifying bifunctional or higher polyfunctional alcohols with polyfunctional saturated-aliphatic, cyclo-aliphatic or aromatic carboxylic acids and/or their anhydrides. Further synthetic organic binders are alkyd resins (polyesters modified with unsaturated fatty acids, fatty oils or higher synthetic carboxylic acids) and also chemically modified alkyd resins, examples being styrenated, acrylated or urethanized. Further suitable organic binders include acrylic resins (polyacrylates) in the form of their homopolymers and copolymers, e.g. styrene acrylate and polyacrylic polyols.

Water-dilutable acrylic resins are particularly preferred as binder.

The paint formulation of the invention comprises, as matting agent, from 0.5 to 15 wt %, preferably from 3 to 10 wt %, of a HAp having a Dv50 comprised between 10 and 50 μm, a Dv90 below 85 μm, and a Dv10 above 3 μm.

Preferably, the HAp of the invention has a Dv50 comprised between 15 and 45 μm, more preferably between 15 and 35 μm.

Preferably, the Dv90 of the HAp is below 75 μm, more preferably below 65 μm.

Preferably, the Dv10 is above 4 μm.

In a preferred embodiment, the mode of the particle dimension distribution of the Hap of the invention is comprised between 15 and 40 μm, more preferably between 17 and 35 μm.

In a particularly preferred embodiment, the Dv100 of the Hap is below 150 μm, more preferably below 120 μm, most preferably below 100 μm.

Hydroxyapatite, Ca₁₀(PO₄)₆(OH)₂, is a compound present in the human body, being the main mineral constituent of bone tissue and of enamels. Indeed, 99% of the calcium in the human body is stored in bone tissue in the form of hydroxyapatite. Thanks to its excellent biocompatibility, synthetic hydroxyapatite is used for artificial bones, artificial tooth roots, bone fillers, pharmaceutical carriers, cosmetics, such as toothpastes, sunscreens, and the like.

The hydroxyapatite of the invention can be of natural or synthetic origin.

In a preferred embodiment of the invention, the hydroxyapatite is a natural hydroxyapatite.

Stoichiometric HAp is basically composed of calcium and phosphorus with molar ratio of Ca/P equal to 1.67. However, natural HAp is non-stoichiometric and is either deficient in calcium or phosphorus. Calcium positions are the most common vacancy in natural Hap, where traces of cations such as Na⁺, Mg²⁺, and Al³⁺ are substituted in the calcium positions, while carbonate anions can substitute for either phosphate or hydroxyl ions and fluoride anions can substitute for hydroxyl ions.

Natural hydroxyapatite can be extracted from biological sources or wastes such as mammalian bones (e.g. bovine, camel, and horse bones), marine or aquatic sources (e.g. fish bone and fish scale), shell sources (e.g. clam, eggshell, etc.), plants and algae, and also from mineral sources (e.g. limestone).

Calcination and alkaline heat treatment are the most popular methods for fabrication of Hap from mammalian bones and marine or aquatic sources. Calcination being the most preferred.

The calcination process removes the organic constituent in the bone by the thermal process. The organic matter is converted to carbon dioxide and ash (calcium phosphate compounds).

In the alkaline heat treatment, an alkaline solution usually NaOH is used to remove the organic matter from the bone. The NaOH solution hydrolyzes the organic component in the bone and the remaining calcium phosphate is rinsed and separated

[symbol]

[symbol] using filtration.

The shells, rich of CaCO₃, are usually calcined to form CaO which along with excess of CaCO₃ will be used for further treatment, for example sol-gel precipitation or wet chemical precipitation, to produce high purity HAp.

After the extraction, the natural Hap obtained can be milled and sieved to obtain the desired dimension values.

Preferably, the natural Hap suitable for the realization of the present invention is obtained following the process described in WO 2020/193750.

In another preferred embodiment of the invention, the hydroxyapatite is a synthetic hydroxyapatite.

According to a specific embodiment of the invention, the synthetic hydroxyapatite is a hydroxyapatite wherein calcium ions are partially replaced by a variety of metal ions, to form the corresponding metal-substituted hydroxyapatite.

According to another specific embodiment of the invention, the synthetic HAp is a carbonate-hydroxyapatite (C-Hap). A carbonate-hydroxyapatite is a HAp, wherein hydroxyl or phosphate anions are partially replaced by carbonate anions. Synthesized C-HAp mimics for composition, structure, dimensions and morphology bone apatite crystals more closely than “pure” synthetic Hap, and for these reasons it is also defined “biomimetic” hydroxyapatite.

In a further specific embodiment of the invention, the synthetic hydroxyapatite is a Hap wherein hydroxyl anions are partially replaced by fluoride and/or chloride anions.

In another specific embodiment of the invention, the synthetic hydroxyapatite is a metal-substituted carbonate-hydroxyapatite.

The processes for the preparation of synthetic hydroxyapatite are well known in the art. Synthetic HAp can be fabricated through various processes, such as dry processes (solid-state and mechanochemical), wet processes (chemical precipitation, hydrolysis, sol-gel, hydrothermal, emulsion, and sonochemical), and high temperature processes (combustion and pyrolysis). Preferably, the HAp of the invention is obtained by chemical precipitation by contacting a source of calcium cations with a source of phosphate anions.

According to an embodiment of the invention, the chemical precipitation process for the preparation of the synthetic HAp of the invention comprises the steps of:
I. providing an aqueous solution or suspension comprising a Ca cation source;
II. mixing the aqueous solution or suspension of step I) with an aqueous solution or suspension comprising a phosphate anion source;
III. stirring the mixture to allow the formation of a suspension of HAp particles;
IV. separating the hydroxyapatite particles from the suspension obtained from step III) and drying the wet particles.

Suitable sources of calcium cations are calcium fluoride, calcium chloride, calcium nitrate, calcium carbonate, calcium hydroxide, calcium acetate, or combinations thereof. Preferably, the source of calcium cations is calcium hydroxide or calcium chloride. More preferably, the source of calcium cations is calcium hydroxide.

Preferably, the aqueous solution or suspension of step I) has a pH comprised between 7 and 13, more preferably between 8 and 12.

Suitable sources of phosphate anions are disodium hydrogen phosphate, sodium dihydrogen phosphate, orthophosphoric acid, dipotassium hydrogen phosphate, potassium dihydrogen phosphate, di-ammonium hydrogen phosphate or combinations thereof. Preferably, the source of phosphate anions is orthophosphoric acid.

Step II) can be carried out over a time comprised between 30 minutes and 2 hours at a temperature below 60° C., preferably from 30 to 50° C.

In the process of the invention, step III) allows the development of the particles of hydroxyapatite to the desired dimensions and structure. Usually, step III) is carried out for at least 6 hours at a temperature below 60° C. Preferably, step III) is carried out for 6 to 36 hours and more preferably for 12 to 24 hours at a temperature comprised between 25 and 45° C.

The separation of step IV) can be carried out using techniques well known to the person skilled in the art, for example by decantation, centrifugation, filtration, spray-drying and the like.

The wet Hap particles can be dried, for instance by freeze-drying or drying in a ventilated or a vacuum oven at 40-90° C.

If needed, at the end of the process, the Hap particles can be grinded and/or sieved to obtain a Hap having the appropriate dimensions suitable for the use as matting agent.

In a preferred embodiment, the suspensions of Hap particles are spray-dried to directly obtain the appropriate particle dimensions suitable for the use as matting agent. Advantageously, the Hap obtained from spray drying show a more homogeneous particle size distribution and a more spherical shape the Hap obtained from grinding.

In a preferred embodiment, the process may also comprise an additional step of washing the separated particles with water or a basic solution prior to the drying. The washing operation can be repeated several times, if desired. Advantageously, the optional washing step is useful for removing any reagent residues possibly adsorbed or trapped by the particles aggregates.

In order to obtain a metal substituted HAp, the aqueous solution or suspension of step I) may further comprise a source of suitable metal cations. Examples of suitable metal cations are Copper (Cu²⁺), Aluminium (Al³⁺), Magnesium (Mg²⁺), Zinc (Zn²⁺), Cobalt (Co²⁺), Iron (Fe³⁺and Fe²⁺), Silver (Ag⁺), Manganese (Mn²⁺), Strontium (Sr²⁺), Titanium (Ti⁴⁺) or combinations thereof. Suitable sources are oxides or salts of these cations or mixtures thereof. Suitable salts of metal cations are acetate, nitrate, citrate, fluoride, chloride, hydroxide and carbonate salts of the above metals or combinations thereof. Preferably, the source of metal cations is a carbonate salt.

According to a preferred embodiment of the invention, the metal-substituted HAp contains a cation selected among Mg, Cu, Zn, Ag cations or combinations of these cations.

According to a more preferred embodiment, the metal-substituted HAp contains Zn, Cu and Ag cations or combinations thereof.

Carbonate-hydroxyapatite can be successfully synthesized by carefully selecting the operating conditions (temperature, concentration, etc.) and reagents. Particles of C-HAp may be simply prepared by agitating the solution or suspension, for example by means of a mechanical stirrer, in the presence of a carbon dioxide gas or may be achieved by bubbling a carbon dioxide gas into the liquid phase or by combining a mechanical stirring with a gas bubbling.

The carbon dioxide gas may be a gas containing carbon dioxide. Pure carbon dioxide gas or air may be used as the carbon dioxide gas.

Alternatively, a carbonate salt may be added in advance to the aqueous solution or suspension of step I) or to the solution or suspension comprising the phosphate source. Otherwise, a carbonate salt may be added to the mixture obtained in step II). Further, step II) may be carried out by simultaneously adding to the aqueous solution or suspension of step II) a solution or suspension containing the carbonate salt and another solution or suspension containing phosphate anions.

Ammonium carbonate, sodium bicarbonate, sodium carbonate, potassium carbonate, or potassium bicarbonate may be used as the carbonate salt. Alternatively, in the case of a metal-substituted C-Hap, the carbonate source can be a carbonate salt of the substituting metal.

Beside the above ingredients, the paint formulations of the invention may optionally comprise further conventional additives, such as rheology modifiers (thickeners), surface-active agents and defoamers.

Thickeners are used for rheological control purposes and particularly for increasing viscosity and imparting the required rheological properties to the paint formulations. The thickeners for latex paints can be inorganic thickener, such as bentonite, natural polymers, such as guar, xanthan or microfibrillated cellulose, synthetic polymers, such as polyacrylate or polyurethane based thickener, or semi-synthetic polymers, or chemically modified natural polymers. Among the chemically modified natural polymers, the thickeners of choice can be derivatives of cellulose, including carboxymethyl cellulose, hydroxyethyl cellulose, ethyl hydroxyethyl cellulose, methyl cellulose, methyl hydroxylethyl cellulose, methyl hydroxypropyl cellulose, hydrophobically modified hydroxyethyl cellulose and blends of them. Polygalactomannans derivatives, such as hydroxyethyl or hydroxypropyl derivatives of guar or cassia, are other suitable thickeners for the preparation of the paint formulation of the invention.

Surface-active agents used are preferably dispersants, wetting agents and emulsifiers as widely used in the commercially paint and coating materials. In particular, they may be nonionic, anionic, cationic or amphoteric, and monomeric or polymeric, in nature. Certain suitable thixotropic agents may also be included within these paint formulations as well. These would include, without limitation, phyllosilicates, pyrogenic silicas, and organic compounds based, for example, on high molecular mass polyolefins, hydrogenated castor oil, polyamides or polyacrylates.

Suitable defoamers include those based on natural oils or mineral oils, chemically modified silicones and silica materials.

Besides the above mentioned additives, the paint formulations of the invention may include other standard paint additives and adjuvants, such as water-softeners, pH regulators, further film-forming and levelling assistants, dryers (siccatives), anti-skinning agents, anti-fouling agents, UV protectants and stabilizers, biocides, and the like. Solvents may also be present within these paint formulations. Preferred solvents include water-soluble or water-miscible solvents. Solvent free paint formulations are particularly preferred.

The paint formulations of the invention can be used for the preparation of many different kinds of paints, such as dispersion paints, wall paints, interior paints, rub-fast paints, washable paints, satin paints, exterior paints, facade paints, filler paints, silicate paints, single-layer paints, double-layer paints, structural paints, concrete coatings, spray paints, etc.

### EXAMPLES

In the Examples, the following ingredients were used:
Tioxide R-HD2=titanium dioxide pigment, d50 0.24 μm (Huntsman Corporation)
PU1=polyurethane beads, d50 5-8 μm;
PU2=polyurethane beads, d50 22-30 μm;
PA1=polyacrylate microspheres, d50 8-12 μm;
PA2=polyacrylate microspheres, d50 18-22 μm;
Acematt OK607 =fine particle sized wax-treated precipitated silica, d50 4.4 μm, (Evonik Industries AG);
Calcitec V 40 S=99.5% calcium carbonate; d50 6 μm, (Mineraria Sacilese S.p.A.);
Byk 024=VOC-free silicone-containing defoamer (BYK-Chemie GmbH);
Reotan HS=polyacrylic acid dispersant (Lamberti S.p.A.);
Crilat 4830 32 acrylic emulsion binder (VINAVIL S.p.A.);
Viscolam PS 170 AIR=associative polyurethane thickener (Lamberti S.p.A.).

The Hap reported in Table 1 were tested.

TABLE 1

| | | Dv10 | Dv50 | Dv90 | Mode |
|---|---|---|---|---|---|
| | Origin | (μm) | (μm) | (μm) | (μm) |
| HAp1 | Synthetic C-HAp, Spray Dried | 5.0 | 18.2 | 42.1 | 23.2 |
| HAp2 | Synthetic C-HAp, Spray Dried | 3.8 | 20 | 54.2 | 32.1 |
| Hap3 | Zn and Mg | 4.1 | 17.5 | 40.3 | 22.6 |
| | substituted Synthetic C-HAp. | | | | |
| | Spray Dried | | | | |
| HAp4 | Zn and Mg | 3.8 | 20.1 | 54.7 | 35.4 |
| | substituted Synthetic C-HAp. | | | | |
| | Spray Dried | | | | |
| HAp5* | Synthetic C-HAp, Grounded | 2.1 | 9.8 | 58.2 | 6.0 |
| HAp6* | Natural HA, Grounded | 0.54 | 1.01 | 6.04 | 0.72 |

*For use in comparative Examples

Particle dimensions were determined using a Mastersizer 3000 (Malvern Panalytical). Measurements were done at 25° C. under sonication. The particle dimension distributions were calculated as average of three replicates.

### Scanning Electron Microscopy Characterization

The Hap were further characterized by Scanning Electron Microscopy (SEM).

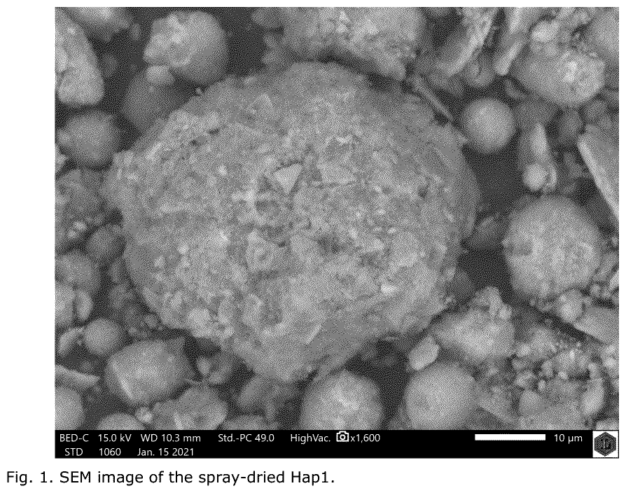

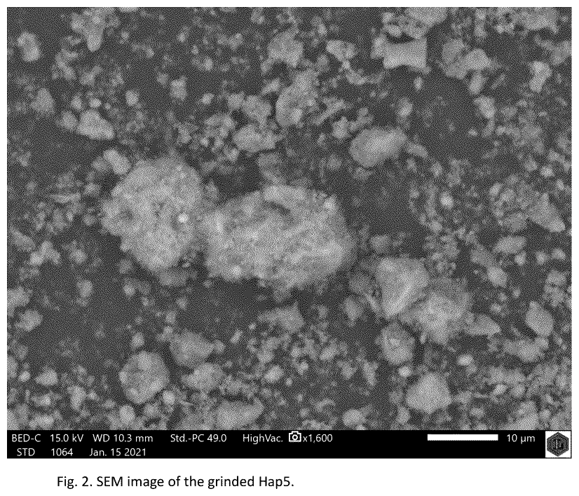

SEM imaging highlighted that, compared to a grinded HAp5 (FIG. 2), the spray-dried HAp1 (FIG. 1) shows a more homogeneous organization of particles.

This characteristic allows to create a more homogeneous surface of the composite that is responsible for the constant gloss reduction and for the high burnishing resistance at different angles of incidence.

### Example 1-12

The performances of the HAp as matting agents were determined on paint formulations with a PVC of 17 and prepared with the commercially available ingredients reported in Table 2.

TABLE 2

| | Ingredients | Weight (%) |
|---|---|---|
| Phase 1 | Water | 5.62 |
| | Propylene Glycol | 3 |
| | Byk 024 | 0.3 |
| | Reotan HS | 0.5 |
| | Preservative | 0.2 |
| Phase 2 | Tioxide R-HD2 | 14.6 |
| Phase 3 | Crilat 4830 | 13.3 |
| | Matting agent | 6.0* |
| | Crilat 4830 | 45.6 |
| | Butyl Diglycol | 3.3 |
| | Byk 024 | 0.2 |
| | Water | 6.98 |
| | Viscolam PS 170 AIR | 0.4 |

*4.0 for Acematt OK 607

The paint formulations were prepared following a three-phase process:
In the first phase, the liquid ingredients of the phase 1 were mixed in a beaker for 10 minutes under stirring (Cowles stirrer at 800 rpm).
Subsequently, titanium dioxide was gradually poured into the mixture and the stirring speed was increased to 1000 rpm for 20 minutes.
In the third phase, a first aliquot of Crilat 4830 (binder) was introduced in order to get enough volume to ensure proper stirring. Subsequently, the matting agent was carefully added under stirring at 500 rpm and, after 10 minutes, the remaining portion of the binder and all the other ingredients following the order reported in Table 2. Finally, the resulting paint formulations were homogenized at 1300-1500 rpm for 10 minutes.

A control paint formulation was also prepared using the same recipe and procedure with TiO₂ as matting agent (Control).

The Brookfield (20 rpm at 20° C.) and Stormer (200 rpm at 20° C.) viscosities of the paint formulations were determined after 24 hours (Table 3).

TABLE 3

Viscosity

| | | Brookfield | Stormer |
|---|---|---|---|
| | Matting Agent | (mPa · s) | (KU) |
| Control* | Tioxide R-HD2 | 5110 | 109.6 |
| Example 1 | HAp1 | 5560 | 109.2 |
| Example 2 | HAp2 | 6120 | 111.4 |
| Example 3 | HAp3 | 5160 | 114 |
| Example 4 | HAp4 | 6720 | 115.8 |
| Example 5* | HAp5 | 4810 | 111 |
| Example 6* | HAp6 | 3165 | 102.3 |
| Example 7* | PU1 | 11900 | 134.3 |
| Example 8* | PU2 | 12320 | 134.9 |
| Example 9* | PA1 | 3895 | 105.1 |
| Example 10* | PA2 | 3380 | 102.2 |
| Example 11* | Acematt OK607 | 3025 | 95.6 |
| Example 12* | Calcitec V 40 S | 3725 | 104.1 |

*Comparative

The paint formulations containing the Hap of the invention show a behavior very similar to that of the Control paint formulation are very close, both at low (Brookfield 20 rpm) and medium-high (Stormer) shear rates. This behavior demonstrates the high compatibility of the Hap of the invention with the other paint ingredients. On the contrary, the Hap of the Example 6 and other known matting agents show a strong influence on the rheology of the paint formulations.
Table 4 shows the viscosity (mPa*s), soon after preparation and after 14 days at 50° C., measured using an Anton Paar MCR 302 rheometer equipped with a cone and plate measuring system (CP-50), at 20° C. and at a shear rate of 3.98 s⁻¹.

TABLE 4

Viscosity

| | Initial | After 14 days |
|---|---|---|
| Control* | 5554 | 3880 |
| Example 1 | 5694 | 3785 |
| Example 5* | 5656 | 3477 |
| Example 6* | 3499 | 2518 |
| Example 7* | 8285 | 6269 |
| Example 8* | 8878 | 6189 |
| Example 9* | 4223 | 3214 |
| Example 10* | 3707 | 2545 |
| Example 11* | 3514 | 3221 |
| Example 12* | 3923 | 2727 |

*Comparative

The viscosity values demonstrate that the HAp of the invention have no effect on viscosity values both soon after preparation, and after 14 days storage at 50° C., allowing the substitution of the titanium dioxide (Control) without any influence on the rheology of the paint.
The same does not apply for other matting agents, in particular for Acematt OK607, that show a viscosity drop compared to the Control, soon after its introduction in the formulation.

### Matting Performances

The paint formulations of the Examples were applied on a Form 1B Penopac Chart (Leneta), using a 120 μm bar-coater. Gloss at different angles of incidence was determined after 5 days of curing at 23° C. and 50% relative humidity. A micro-TRI-gloss glossmeter (BYK) was used for the determinations. The results are reported in Table 5.

TABLE 5

| | Gloss 20° | Gloss 60° | Gloss 85° |
|---|---|---|---|
| Control* | 37 | 70.1 | 89.3 |
| Example 1 | 2.1 | 10.4 | 7.1 |
| Example 2 | 2.5 | 12 | 6.1 |
| Example 3 | 2.2 | 10.3 | 5.8 |
| Example 4 | 2.6 | 12 | 6.2 |
| Example 5* | 3.8 | 20.4 | 26.8 |
| Example 6* | 15.6 | 49.7 | 82.5 |
| Example 7* | 4.3 | 22.1 | 42.3 |
| Example 8* | 2.8 | 14.5 | 12.6 |
| Example 9* | 2.6 | 13.4 | 13.3 |
| Example 10* | 2.3 | 11.5 | 8.4 |
| Example 11* | 2 | 10.5 | 39.8 |
| Example 12* | 6.8 | 33.0 | 50.7 |

*Comparative

These values of gloss clearly demonstrate that the Hap of the invention shows very high matting performances irrespective of the angle incidence. These performances are superior to those of commercial matting agents. In particular, Acematt OK607 shows a high matting efficiency at 20°, but the performance dramatically drops at high angles of incidence.

### Burnishing Resistance

Burnishing resistance of the paints formulations was determined, according to ASTM D 6736, on painted PVC specimens after 11 days of curing at 23° C. and 50% relative humidity. In order to improve the accuracy of the results, each paint formulation was applied on two PVC specimens, with a wet thickness of 200 μm. The gloss values at 85° were measured at 3 different points on each specimen, before and after rubbing. Delta gloss values were calculated by subtracting the gloss average values measured after 20, 40, 60, 80 and 100 rub cycles from the initial gloss value.

The mean delta values of the two replicates for each Examples are reported in Table 6, together with the initial gloss values at 85°. The lower the Delta value the better the performance.

TABLE 6

| | | Δ Gloss 85° | | | | |
|---|---|---|---|---|---|---|
| | Gloss 85° | 20 cycles | 40 cycles | 60 cycles | 80 cycles | 100 cycles |
| Control* | 89.3 | 1.15 | 1.2 | 1.1 | 1.1 | 1.0 |
| Example 1 | 7.1 | 0.5 | 0.9 | 0.8 | 0.9 | 0.9 |
| Example 5* | 26.8 | 1.2 | 1.3 | 1.4 | 1.3 | 1.5 |
| Example 6* | 82.5 | 1.0 | −0.7 | −0.8 | 1.6 | 3 |
| Example 7* | 42.3 | −3.8 | −0.4 | 2.5 | 4.0 | 5.1 |
| Example 8* | 12.6 | 0.5 | 0.0 | 0.4 | 0.9 | 1.1 |
| Example 9* | 13.3 | 0.1 | 0.1 | 0.2 | 0.2 | 0.1 |
| Example 10* | 8.4 | 0.1 | 0.2 | 0.1 | 0.2 | 0.1 |
| Example 11* | 39.8 | 15.4 | 17.6 | 18.6 | 19.5 | 20.3 |
| Example 12* | 50.7 | −0.4 | −0.0 | 0 | −0.3 | −0.2 |

*Comparative

The Hap of the invention shows an excellent burnish resistance, superior to that obtained with other commercial matting agents.

1. A paint formulation having a percent pigment volume concentration (PVC) comprised between 5 and 50% and excellent matt characteristics comprising at least one pigment and/or one filler, at least one binder and, as matting agent, from 0.5 to 15% by weight (wt %) of a hydroxyapatite (Hap) having a Dv50 of between 10 and 50 μm, a Dv90 below 85 μm and a Dv10 above 3 μm, as determined with a laser diffraction particle size analyzer.

2. The paint formulation of claim 1, having a percent PVC comprised between 10 and 40%.

3. The paint formulation of claim 1, comprising from 3 to 10 wt %, of said HAp.

4. The paint formulation of claim 1, wherein said Hap has a Dv50 comprised between 15 and 45 μm.

5. The paint formulation of claim 1, wherein said Hap has a Dv90 below 75 μm.

6. The paint formulation of claim 1, wherein said Hap has a Dv100 below 150 μm.

7. The paint formulation of claim 1, wherein said Hap is a synthetic Hap.

8. The paint formulation of claim 7, wherein said synthetic Hap is a metal-substituted hydroxyapatite.

9. The paint formulation of claim 7, wherein said synthetic Hap is carbonate-hydroxyapatite.

10. A method for imparting excellent matt characteristics to a coating obtained with a paint having a percent PVC<50% comprising the step of:
i) preparing a paint formulation having a percent PVC comprised between 5 and 50% comprising at least one pigment and/or one filler, at least one binder and, as matting agent, from 0.5 to 15% by weight of a hydroxyapatite having a Dv50 of between 10 and 50 μm, a Dv90below 85 μm and a Dv10 above 3 μm, as determined with a laser diffraction particle size analyzer;
ii) optionally adding into the paint formulation water or other conventional paint additives;
iii) applying the resulting paint formulation having percent PVC<50% onto a substrate.

11. The method of claim 10, wherein said paint formulation has a percent PVC comprised between 10 and 40%.

12. The method of claim 10, wherein said paint formulation comprises from 3 to 10 wt % of said HAp.

13. The method of claim 10, wherein said Hap has a Dv50 comprised between 15 and 45 μm.

14. The paint formulation of claim 10, wherein said Hap has a Dv90 below 75 μm.

15. The paint formulation of claim 10, wherein said Hap has a Dv100 below 150 μm.

16. The paint formulation of claim 10, wherein said Hap is a synthetic HAp.

17. The paint formulation of claim 16, wherein said synthetic Hap is a metal-substituted hydroxyapatite.

18. The paint formulation of claim 16, wherein said synthetic Hap is carbonate-hydroxyapatite.
